(19) United States
(12) Patent Application Publication
(10) Pub. No.: US 2015/0232273 A1
(43) Pub. Date: Aug. 20, 2015

(54) ROBOTIC VEHICLE, DATACENTER, AND METHOD FOR MAINTAINING DATACENTER

(71) Applicant: Quanta Computer Inc., Tao Yuan Shien (TW)

(72) Inventors: Maw-Zan JAU, Taipei City (TW); Chao-Jung CHEN, Taipei City (TW); Chih-Ming CHEN, New Taipei City (TW); Wei-Yi CHU, Taipei City (TW)

(73) Assignee: Quanta Computer Inc., Tao Yuan Shien (TW)

(21) Appl. No.: 14/281,184

(22) Filed: May 19, 2014

(30) Foreign Application Priority Data
Feb. 18, 2014 (TW) 103105221

(51) Int. Cl. B65G 1/137; H04L 29/08; G05B 15/02

(52) U.S. Cl. CPC B65G 1/137; G05B 15/02; H04L 67/16; Y10S 901/01

(57) ABSTRACT

A robotic vehicle, a datacenter, and a method for maintaining the datacenter are disclosed. The robotic vehicle comprises a moving apparatus, a robotic arm, a network module, and a processor. The network module receives a network packet. The processor generates the rack location and the component location according to the network packet. The processor controls the moving apparatus to move to the rack location and controls the robotic arm to move to the component location to replace a failed server component.

This application claims the benefit of Taiwan application Serial No. 103105221, filed Feb. 18, 2014, the subject matter of which is incorporated herein by reference.

### BACKGROUND OF THE INVENTION

1. Field of the Invention

The invention relates in general to an electronic apparatus, and more particularly to a robotic vehicle, a datacenter and a method for maintaining the datacenter.

2. Description of the Related Art

The fundamental configuration of a server is basically the same with that of a personal computer (PC). A server comprises a plurality of electronic components such as central processing unit (CPU), memory, hard disc and motherboard. In comparison to the PC, the specifications of some components of the server meet high standards in response to the required services. For example, a server may be equipped with tens of storage apparatuses for storing a large volume of data or equipped with many CPUs or a large-capacity memory for increasing the load capacity of the server.

In recent years, along with the advance in technology, the server has gradually developed to a rack server system from a conventional upright server system which is large in size and occupies a large space. The rack server system, which adopts standard design in the appearance, integrates several chasses and is used in conjunction with the chasses. The design of the rack server aims to reduce the space occupied by the server. Nowadays, a large number of professional network equipment adopts rack structure, and most structures, such as exchangers, routers, and hardware firewalls, are flat type structure like a drawer. In terms of the rack server system, server components can be loaded to the rack from its front, and after the server components are loaded to the rack, the cables of the server components can be extended from the rear of the chassis and received in a cable tray for the convenience of management.

A datacenter normally comprises many rack server systems. Once a server component of the rack server system fails and needs to be replaced or processed, the replacement or processing is very time consuming and requires a large amount of human resources.

### SUMMARY OF THE INVENTION

The invention is directed to a robotic vehicle, a datacenter and a method for maintaining a datacenter which are capable of automatically maintaining and processing the datacenter. Once a server component of the rack server system fails, the failed server component is automatically replaced, not only saving a large amount of maintenance time but also avoiding waste in human resources.

According to one embodiment of the present invention, a robotic vehicle is disclosed. The robotic vehicle comprises a moving apparatus, a robotic arm, a network module, and a processor. The network module receives a network packet. The processor generates the rack location and the component location according to the network packet. The processor controls the moving apparatus to move to the rack location and controls the robotic arm to move to the component location to replace a failed server component.

According to another embodiment of the present invention, a datacenter is disclosed. The datacenter comprises a rack server system, a central management system and a robotic vehicle. The rack server system comprises a server component and a detection apparatus. The detection apparatus detects the server component, and sends a fault message when the server component fails. The central management system determines the server component as a failed server component according to the fault message, and generates a network packet according to a rack location and a component location of the failed server component. The robotic vehicle comprises a moving apparatus, a robotic arm, a network module, and a processor. The network module receives a network packet. The processor generates the rack location and the component location according to the network packet. The processor controls the moving apparatus to move to the rack location, and controls the robotic arm to move to the component location to replace the failed server component.

According to an alternate embodiment of the present invention, a method for maintaining a datacenter is disclosed. The method for maintaining a datacenter comprises: detecting a server component and sending a fault message when the server component fails; determining the server component as a failed server component according to the fault message, and generating a network packet according to a rack location and a component location of the failed server component; receiving a network packet; generating the rack location and the component location according to the network packet; and controlling the moving apparatus to move to the rack location and controlling the robotic arm to move to the component location to replace the failed server component.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a schematic diagram of a datacenter according to the present embodiment of the invention.

FIG. 2 shows a schematic diagram of a robotic vehicle according to the present embodiment of the invention.

FIG. 3 shows a schematic diagram of a rack server system, a maintenance area and a warehouse area.

FIG. 4 shows a flowchart of a method for maintaining the datacenter according to the present embodiment of the invention.

FIG. 5 shows a detailed flowchart of step 46.

### DETAILED DESCRIPTION OF THE INVENTION

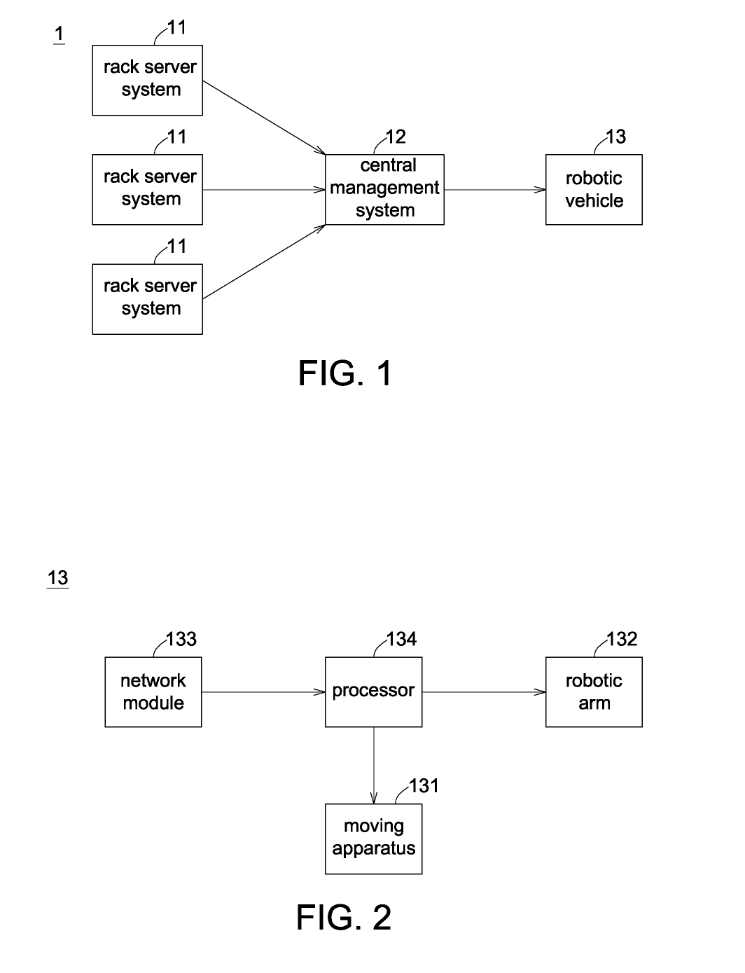

Referring to FIG. 1, a schematic diagram of a datacenter according to the present embodiment of the invention is shown. The datacenter 1 comprises a rack server system 11, a central management system 12 and a robotic vehicle 13. The rack server system 11 comprises a rack, a server component and a detection apparatus. The rack 11 comprises a plurality of slots for receiving the server component. The server component can be realized by a server node, a server fan, a server power supply or a server storage apparatus, and has modular design. The detection apparatus can be realized by a rack management controller (RMC) and a baseboard management controller (BMC). The detection apparatus detects a server component of the rack server system 11, and sends a fault message to the central management system 12 when the server component fails. The central management system 12 determines the server component as a failed server component according to the fault message, and generates a network packet according to a rack location and a component location of the failed server component. The robotic vehicle 13 generates the rack location and the component location according to the network packet. The robotic vehicle 13 replaces the failed server component according to the rack location and the component location.

Refer to FIG. 1 and FIG. 2. FIG. 2 shows a schematic diagram of a robotic vehicle according to the present embodiment of the invention. The robotic vehicle 13 comprises a moving apparatus 131, a robotic arm 132, a network module 133 and a processor 134. The network module 133 receives a network packet. The processor 134 generates the rack location and the component location according to the network packet, controls the moving apparatus 131 to move to the rack location, and controls the robotic arm 132 to move to the component location to replace the failed server component.

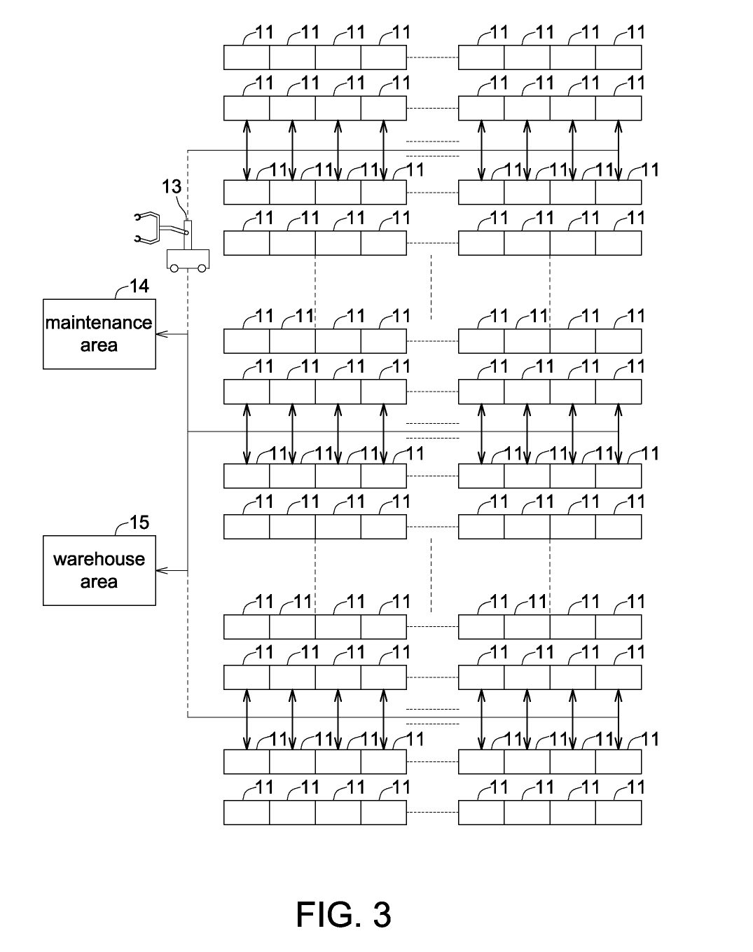

Refer to FIG. 2 and FIG. 3. FIG. 3 shows a schematic diagram of a rack server system, a maintenance area and a warehouse area. When the rack server system 11 needs to replaces a failed server component, firstly, the moving apparatus 131 of the robotic vehicle 13 moves to the rack location, then the robotic arm 132 moves to the component location to unload the failed server component. After the robotic arm 132 unloaded the failed server component, the moving apparatus 131 sends the failed server component to the maintenance area 14. Then, the moving apparatus 131 moves to the warehouse area 15 from maintenance area 14. The robotic arm 132 selects a backup server component from the warehouse area 15, and loads the backup server component to the component location.

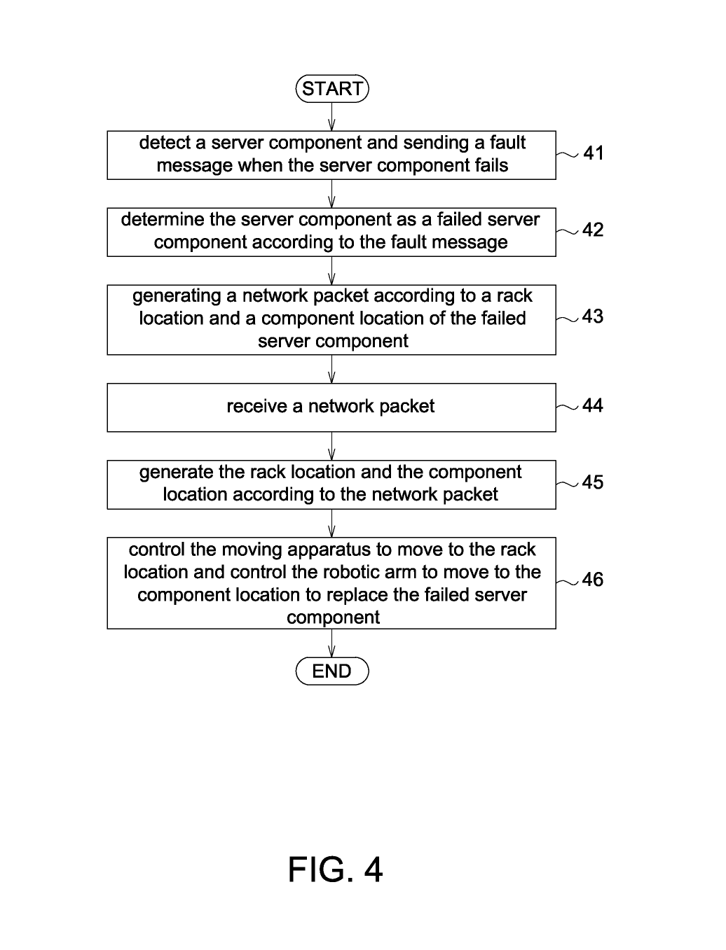

Refer to FIG. 1, FIG. 2 and FIG. 4. FIG. 4 shows a flowchart of a method for maintaining the datacenter according to the present embodiment of the invention. The method for maintaining the datacenter comprises following steps. Firstly, the method begins at step 41, the detection apparatus detects a server component and sends a fault message when the server component fails. Then, the method proceeds to step 42, the central management system 12 determines the server component as a failed server component according to the fault message. Afterwards, the method proceeds to step 43, the central management system 12 generates a network packet according to a rack location and a component location of the failed server component, wherein the network packet can be sent to the robotic vehicle 13 via wireless transmission. Then, the method proceeds to step 44, the network module 133 of the robotic vehicle 13 receives a network packet. Then, the method proceeds to step 45, the processor 134 generates the rack location and the component location according to the network packet. Afterwards, the method proceeds to step 43, the processor 134 controls the moving apparatus 131 to move to the rack location, and controls the robotic arm 132 to move to the component location to replace the failed server component.

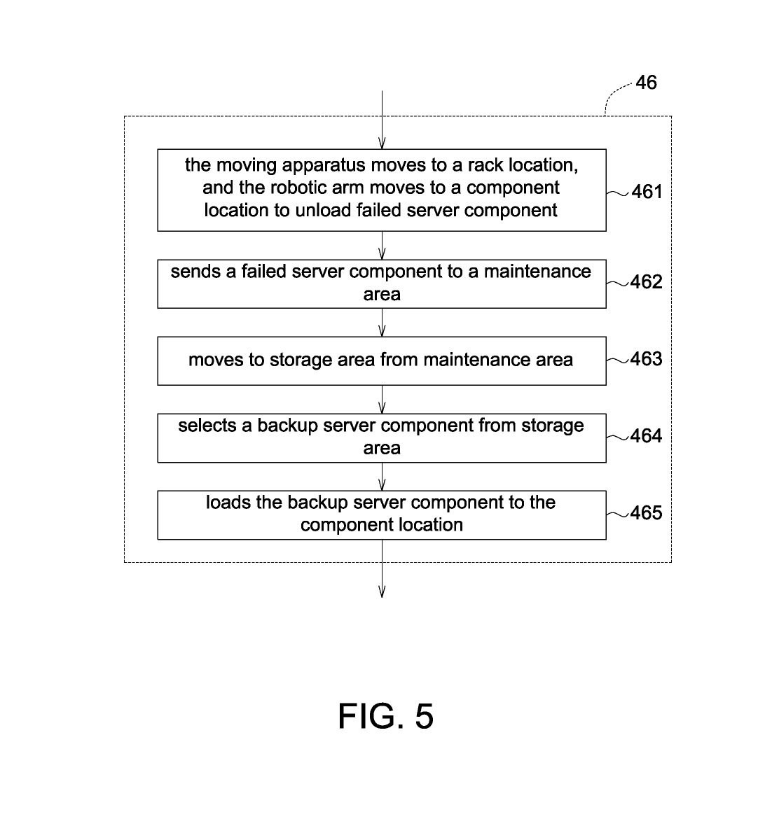

Refer to FIG. 2, FIG. 3 and FIG. 5. FIG. 5 shows a detailed flowchart of step 46. The step 46 further comprises following sub-steps. In step 461, the moving apparatus 131 moves to a rack location, and the robotic arm 132 moves to a component location to unload failed server component. In step 462, the moving apparatus 131 sends a failed server component to a maintenance area 14. In step 463, the moving apparatus 131 moves to warehouse area 15 from maintenance area 14. In step 464, the robotic arm 132 selects a backup server component from warehouse area 15. In step 465, the robotic arm 132 loads the backup server component to the component location.

The robotic vehicle, the datacenter and the method for maintaining the datacenter disclosed in the above embodiments are capable of automatically maintaining and processing the datacenter. Once a server component of the rack server system fails, the failed server component is automatically replaced, not only saving a large amount of maintenance time but also avoiding waste in human resources.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A datacenter, comprising:
a rack server system, comprising:
a server component;
a detection apparatus for detecting the server component and sending a fault message when the server component fails;
a central management system for determining the server component as a failed server component according to the fault message and generating a network packet according to a rack location and a component location of the failed server component;
a robotic vehicle, comprising:
a moving apparatus;
a robotic arm;
a network module for receiving the network packet; and
a processor for generating the rack location and the component location according to the network packet, controlling the moving apparatus to move to the rack location, and controlling the robotic arm to move to the component location to replace the failed server component.

2. The datacenter according to claim 1, wherein the moving apparatus moves to the rack location, the robotic arm moves to the component location to unload the failed server component, the moving apparatus sends the failed server component a maintenance area, the moving apparatus moves to a warehouse area from the maintenance area, and the robotic arm selects a backup server component from the warehouse area and loads the backup server component to the component location.

3. The datacenter according to claim 1, wherein the server component can be realized by a server node, a server fan, a server power supply or a server storage apparatus.

4. A robotic vehicle, comprising:
a moving apparatus;
a robotic arm;
a network module for receiving a network packet; and
a processor for generating a rack location and a component location according to the network packet, controlling the moving apparatus to move to the rack location, and controlling the robotic arm to move to the component location to replace a failed server component.

5. The robotic vehicle according to claim 4, wherein the moving apparatus moves to the rack location, the robotic arm moves to the component location to unload the failed server component, the moving apparatus sends the failed server component to a maintenance area, the moving apparatus moves to a warehouse area from the maintenance area, and the robotic arm selects a backup server component from the warehouse area and loads the backup server component to the component location.

6. The robotic vehicle according to claim 4, wherein the server component can be realized by a server node, server fan, server power supply or server storage apparatus.

7. A method for maintaining a datacenter, comprising:
detecting a server component and sending a fault message when the server component fails;
determining the server component as a failed server component according to the fault message and generating a network packet according to a rack location and a component location of the failed server component;
receiving a network packet;
generating the rack location and the component location according to the network packet; and
controlling the moving apparatus to move to the rack location and controlling the robotic arm to move to the component location to replace the failed server component.

8. The maintaining method according to claim 7, wherein the replacement step comprises:
moving the moving apparatus to the rack location and moving the robotic arm to the component location to unload the failed server component;
sending the failed server component to a maintenance area;
moving the failed server component to a warehouse area from the maintenance area; and
selecting a backup server component from the warehouse area and loading the backup server component to the component location.

9. The maintaining method according to claim 7, wherein the server component can be realized by a server node, a server fan, a server power supply or a server storage apparatus.
